(19) United States
(12) Patent Application Publication
(10) Pub. No.: US 2020/0280756 A1
(43) Pub. Date: Sep. 3, 2020

(54) REMOTE CONTROL AND INTEGRATION OF ELECTRONIC DEVICES IN A MEDIA SYSTEM

(71) Applicant: Logitech Europe S.A., Lausanne (CH)

(72) Inventors: Meher Vurimi, San Jose, CA (US); Xavier Caine, San Jose, CA (US); Ian Crowe, Berkeley, CA (US)

(21) Appl. No.: 16/290,680

(22) Filed: Mar. 1, 2019

(51) Int. Cl. H04N 21/422; H04N 21/45

(52) U.S. Cl. CPC H04N 21/42203; H04N 21/42215; H04N 21/4524; H04N 21/4532

(57) ABSTRACT

A system performs operations including detecting input data from a user by a UI and transmitting the input data to an intent detection service, which provides a media type and identifier. The system then determines sources that are capable of providing media content associated with the media type and media identifier, determines one or more operational properties of the media content and available media resources of a media presentation system that are capable of accessing the one or more sources and presents the media content based on the operational properties. The system further selects the available media resources that are capable of presenting the media content based on the operational properties of the media content and the capabilities of the available media resources and operational settings, and generates control data to enable the combination of the selected media resources to present the media content according to the corresponding operational settings.

### BACKGROUND

Remote control devices have been used for many years to control various electronic devices in home entertainment systems. Some of these devices can include, for example, televisions (TVs), audio/video receivers (AVRs), amplifiers, media players (e.g., DVD, streaming media systems), gaming consoles, entertainment/media consoles (e.g., Roku®, AppleTV®), cable consoles (e.g., DirecTV®, Comcast®), and the like. Each system can come with its own remote control, making the operation of the overall system cumbersome and often confusing, particularly when specific sequences of commands must be sent to achieve a desired result that can get progressively more complex as more devices are included in the particular entertainment system. For example, simply watching a show may require a user to use multiple remotes to sequentially turn on a TV, turn on a media console, select a correct input to the TV to route content from the media console to the TV, select a program from the media console, set operating conditions (e.g., volume, brightness, etc.), and more.

These issues have ultimately led to the advent of “universal” remote controllers that allow users to operate some or all of the electronic components in a home entertainment system via a single control device, which helped to alleviate the problem of multiple remotes. Universal remote often have dedicated buttons to select the target device to control. For instance, the user can switch the universal remote to “TV” to change a volume, then switch to “DVR” to select media content for playback. However, new challenges were presented that further complicated matters.

Universal remotes are often populated with a very large number of buttons, which can be intimidating to some users. Further, some universal remotes may be programmed by entering identifier codes for particular electronic units in the home entertainment system so that the universal remote can load operating parameters/control configurations. This often requires a code reference that may have multiple available codes per brand/model, which can be time consuming to program and daunting to the uninitiated in this endeavor. Some universal remotes can sample control signals (e.g., encoded infra-red signals) from an OEM remote to program its operation, however this may be labor-intensive and can require a significant time investment by the user to sample each OEM remote and associate the samples with one or more particular buttons on the universal remote. Such systems can further present problems as the reliability of such programming can be based on the stability of the sampled codes, which can vary widely in quality from manufacturer to manufacturer. In some systems, “macros” can be used to program a single button to perform a sequence of pre-defined events to configure the system to perform a desired function (e.g., play content from a particular media console). Programming macros can be non-intuitive and may require a heightened technical ability and understanding by the user to configure reliable and useful settings; thus, most users may resort to paying installation contractors to set up their remotes. However, when new elements are added or removed from an existing system, macros, samples, and/or previously set controls often need to be reconfigured, which often disincentivizes their continued use. Thus, better devices are needed that are more intuitive, applicable, and expandable to better adapt to the rapidly changing home entertainment consumer market.

### BRIEF SUMMARY

In some embodiments, a system may include one or more processors and one or more non-transitory computer-readable storage mediums containing instructions configured to cause the one or more processors to perform operations including: detecting input data from a user by a user interface device; transmitting the input data to an intent detection service; receiving intent data from the intent detection service, wherein the intent data includes at least a media type and a media identifier title derived from the input data; determining one or more sources that is capable of providing media content associated with at least the media type and media identifier; determining one or more operational properties of the media content, the operation properties corresponding to how the media content is configured to be output; determining available media resources of a media presentation system that are capable of accessing the one or more sources and presenting the media content based on the operational properties; selecting a combination of the available media resources that is capable of presenting the media content based on the operational properties of the media content and the capabilities of the available media resources; determining operational settings of the combination of the selected media resources; generating control data operable to enable the combination of the selected media resources to present the media content according to the corresponding operational settings; and transmitting the control data to the media resources. In some aspects, the user interface device includes a microphone controlled by at least one of the one or more processors, and wherein the input data from the user is voice data.

In certain embodiments, the one or more non-transitory computer-readable storage mediums may further contain instructions that cause at least one of the one or more processors to perform operations including at least one of: receiving user preferences, the user preferences corresponding to a user's selected preference for presenting the media content; receiving system preferences, the system preferences corresponding to preset system settings for presenting the media content; and receiving system recommendations, the system recommendations corresponding to system recommended settings for presenting the media content, where the operational settings of the combination of the selected media resources are further based on the at least one of the user preferences, system preferences, and system recommendations, and where the generating control data is further based on the at least one of the user preferences, system preferences, and system recommendations. The intent data can be further derived from at least one of user preferences or the operational properties of the media resources. In some implementations, the determining available media resources of the media presentation system that are capable of accessing the one or more sources can include compiling the list of available media resources of the media presentation system based on a user input. The determining available media resources of the media presentation system that are capable of accessing the one or more sources may include polling the media presentation system for a list of available media resources of the home entertainment system. In some implementations, the user's selected preference for presenting the media content may correspond to at least one of a video output, audio output, or internet-of-things accessory output. The user interface device may be a remote control device.

In further embodiments, the instructions can be further configured to cause the one or more processors to perform operations including: determine a location of the user, where selecting a combination of the available media resources that is capable of presenting the media content is further based on the location of the user. In some cases, the control data may include: power data configured to power on any of the combination of the available media resources that are turned off; display data configured to control display parameters of a display device of the combination of the available media resources to present the media content; and audio data configured to control audio parameters of an audio system of the combination of the available media resources to present the media content. The display data and audio data can be sent a predetermined period of time after the power data is sent, the predetermined period of time corresponding to an amount of time to power on the corresponding combination of the available media resources. In some implementations, the control data may include a timing sequence of control commands configured to sequentially power up the combination of the available media resources that ensures that each of the available media resources in an operational state to receive and implement its corresponding control commands. The available media resources may include a plurality of independent media platforms, the independent media platforms being closed systems that are not in direct electrical communication with one another. In some embodiments, the media content can be a media channel, a media application, a media program, or the like.

In certain embodiments, a remote control system configured for operating a home entertainment system, the system including: one or more processors; and one or more non-transitory computer-readable storage mediums containing instructions configured to cause the one or more processors to perform operations including: determining system data including available media resources coupled to the home entertainment system, the media resources including a plurality of independent media platforms; receiving user data corresponding to user preferences for presenting a plurality of types of media content; detecting a voice input data from a user, the voice input data detected by a microphone coupled to the one or more processors; encoding the voice input data to a first format; wirelessly transmitting the encoded voice input data encoded in the first format to a remote entity, the encoded voice input data transmitted via a transceiver coupled to the remote control and controlled by the one or more processors; receiving intent data from the remote entity in a second format, wherein the intent data includes a request for a first media content that is derived from the voice input data, the first media content being at least one of the plurality of types of media content; determine one or more sources for the first media content; determining available media resources for accessing the one or more sources and presenting the first media content on the home entertainment system; selecting a combination of the available media resources that is capable of presenting the first media content based on at least one of: the user preferences; operational capabilities of the available media resources; and a type of the first media content; determining operational settings of the combination of available media resources based on the user preferences; generating control data operable to enable each of the combination of the available media resources to present the first media content according to their corresponding operational settings, the remote control system not physically routing the first media data; and controlling the combination of the available media resources with the generated control data.

In further embodiments, the control data of the remote control system can include: power data configured to power on any of the combination of the available media resources that are turned off; display data configured to control display parameters of a display device of the combination of the available media resources to present the media content; and audio data configured to control audio parameters of an audio system of the combination of the available media resources to present the media content, where the display data and audio data is sent a predetermined period of time after the power data is sent, the predetermined period of time corresponding to an amount of time to power on the corresponding combination of the available media resources. In some aspects, the independent media platforms are closed systems that are not in electrical communication with one another. In some cases, the media content can be a media channel, a media application, or a media program. The computer readable storage mediums may further contain instructions that cause one or more processors and perform operations including: receiving user data corresponding to user preferences for presenting a plurality of types of media content.

In some embodiments, determining available media resources of the home entertainment system that are capable of accessing the one or more sources can include compiling the list of available media resources of the home entertainment system based on a user input. Some embodiments can include determining available media resources of the home entertainment system that are capable of accessing the one or more sources includes polling the home entertainment system for a list of available media resources of the home entertainment system. The user data can be manually input by a user or includes configurable preset default user preferences. The control data may include a timing sequence of control commands configured to sequentially power up the combination of the available media resources that ensures that each of the available media resources in an operational state to receive and implement its corresponding control commands. In some cases, the user preferences can be configured in a hierarchy that gives a higher priority to user preferences established by users with higher user privileges.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The detailed description is set forth with reference to the accompanying figures.

FIG. 1 shows a universal remote control and hub configured to control an operation of a home entertainment multi-media system, according to certain embodiments.

FIG. 2 shows a simplified block diagram of a remote control device, according to certain embodiments.

FIG. 3 shows a simplified block diagram of a hub, according to certain embodiments.

FIG. 4 is a simplified flow chart showing aspects of a method for configuring one or more devices in a system to play requested media content in response to a voice command on a remote control device, according to certain embodiments.

FIG. 5 is a simplified flow chart showing aspects of a method for controlling a multi-media system using a remote control and hub, according to certain embodiments.

FIG. 6 is a simplified flow chart showing aspects of a method for turning on a device after receiving a corresponding verbal command using aspects of a home entertainment system, according to certain embodiments.

FIG. 7 is a simplified flow chart showing aspects of a method for launching an application on a media resource in response to a corresponding verbal command using aspects of a home entertainment system, according to certain embodiments.

FIG. 8 is a simplified flow chart showing aspects of a method for tuning a media resource to a particular channel in response to a corresponding verbal command using aspects of a home entertainment system, according to certain embodiments.

FIG. 9 is a simplified flow chart showing aspects of a method for selecting particular media content in response to a corresponding verbal command using aspects of a home entertainment system, according to certain embodiments.

### DETAILED DESCRIPTION

Aspects of the present disclosure relate generally to home multi-media systems, and more particularly to a smart remote control and hub solution to communicate with and seamlessly integrate devices, applications, and content of a home entertainment multi-media system in user-friendly manner, according to certain embodiments.

In the following description, various examples of a smart remote control/hub system for seamlessly integrating devices, applications, and content in a home entertainment system are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

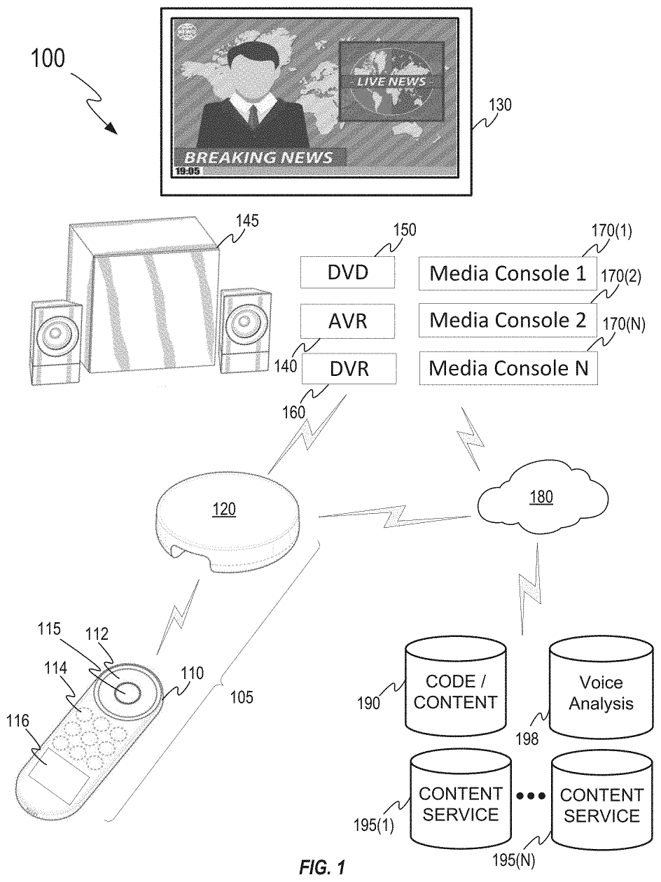

The following high level summary is intended to provide a basic understanding of some of the novel innovations depicted in the figures and presented in the corresponding descriptions provided below. Aspects of the invention relate to a system-agnostic, voice-controlled universal remote control and hub system (see, e.g., FIG. 1) that can configure any device in a home entertainment system to operate and play any available media content through user-friendly voice-activated commands. This is possible by analyzing a context of a user's intent from a voice command at a higher level of abstraction to inform which operation to perform (e.g., play a particular program) that is independent of any particular media platforms or other resources in the home entertainment system. For example, if a user says “watch ‘Best Friends,’” (a TV program) there are many steps that need to be performed before the show can play will play on the user's television. Each device that delivers the show (media content) needs to be turned on and configured to the right settings. For instance, the TV, audio device (e.g., AVR and audio system), and media content provider, which can be a device and/or an application to play content (e.g., DirecTV®, Roku®, Netflix®, etc.) needs to be powered on or launched, their inputs and connections need to be appropriately configured, and the media content needs to be selected. One way such embodiments are set apart from other contemporary systems is that the user requests can be managed agnostically and unencumbered by any limitations of any particular media resource, content provider, or the like, in the home entertainment system as media content is configured based on, e.g., preferred operational settings and/or historical/preset usage preferences, rather than on the limited capabilities of any particular media resource.

To illustrate this point, the show “Best Friends” may have previous shows archived on a first media resource (e.g., media platform such as Netflix®) and a new episode may be playing on a second media resource (e.g., set top box such as DirecTV®). The system may opt to select the second media resource for providing the media content as the user may historically watch newly aired episodes at that particular airtime rather than play older episodes. In some cases, each media resource may have different audio capabilities. Thus, the system may maximize audio delivery in a 7.1 (8-channel) surround sound format for the first media resource, and deliver stereo (2-channel) audio on the second media resource. In another example, if a user wants to watch a particular sports game with the video resolution being equal (e.g., 4K resolution) for two available media resources, then the system may opt to select the media resource with the best available audio capabilities. That is, the system knows available media resources and corresponding capabilities and based on the request for media content, can select and configure preferred media resources in the home entertainment system to best present that media content to the user based individual media resource capabilities and user preferences. This is not possible in other contemporary systems as a first media platform (e.g., Roku®) is not typically aware of the capabilities of other media platforms (e.g., DirecTV®), and even assuming they could be, selecting a competing media platform to best present requested content based on a user's intent (derived from the voice command or “voice data”) would not be supported as most media platforms are self-contained eco-systems.

Another advantage of the system is that it can wirelessly manage content delivery. That is, the system does not require hard-wired connections to each and every media resource in the home entertainment system in order to provide content in the novel manner described above. This distinction can be better appreciated by understanding how some conventional systems operate. In some contemporary systems, each media resource may be physically and electrically connected to one or more central controllers via one or more hardwired connection protocols (e.g., high-definition multimedia interface (HDMI), coaxial, twisted pair, fiber-optic, etc.). In response to a user pressing a button to watch a program on a particular media platform, the central controller may simply route the media platform to a display device by switching the display device's input to the media platform (e.g., switch to “HDMI 1”). The central controller may not necessarily know the type of media platform it is or its capabilities, but simply routes the correct signal chain. In contrast, the remote and hub system makes routing decisions based on the desired media content such that the particular media platform is selected based on a decision to use that particular media resource to provide the media content in the manner intended by the user and does not need to be physically integrated within the system to coordinate the task. Furthermore, typically most or all of the content and/or output in central-controller-type conventional systems go directly through the controller. That is, the central controller physically receives/accesses/routes the content and/or output to an intended destination. In contrast, the remote/hub systems described herein can cause the various system elements to communicate/work directly with each other (e.g., provide content, display received content, route and play audio, configure operational settings, etc.) as the remote/hub system can simply send commands without requiring the various media content to be routed to (e.g., passed through) the hub as a central node. The hub can make decisions based on knowledge of system capabilities (e.g., 7.1 audio available, 4K resolution available, channel content available, etc.), based on metadata about the content, and the like.

To enable the remote control and hub system to control a home multi-media system in the manner described above, the system can automatically poll a multi-media system and/or be programmed to detect and wirelessly communicate with each media resource directly (e.g., by direct wireless communication) or indirectly (e.g., setting a volume of 5.1 speakers indirectly by controlling a corresponding AVR). The system can access a local and/or remote database to know capabilities and control protocols for each media resource including corresponding content. Further, the system can maintain a database(s) (locally or remotely) to store user preferences for video, audio, and media management. An example of media management may include knowing the capabilities of each media resources so that certain conflicts can be resolved. For example, if a DVR is using all available receiver channels on a set top box to simultaneously record content and the user wants to watch an additional program on set top box, the system may search for other media resource in the multi-media system that can provide the same content. In such cases, the system may opt to cancel one of the DVR recordings and utilize that channel if the desired media content is best presented by the media resource (e.g., video resolution and audio presentation) and is prioritized by the user (e.g., live sports). Alternatively, the system may maintain the DVR recordings and play media content from another resource if the recording is prioritized and/or the other resource has acceptable operational settings for the particular media content per the user's preferences. To reiterate, the selection of the media resource is based on an analysis of the media content and the user's intent (informed by the user preferences), which can be system/platform agnostic and at a level of abstraction that is simply not presented in contemporary multi-media systems. These aspects and more are described in the various embodiments and description of figures that follow.

### Entertainment System Overview

FIG. 1 shows a universal remote control 110 and hub 120 (referred to collectively as “remote/hub system 105” or “remote/hub 105”) configured to control an operation of a home entertainment multi-media system (“system”) 100, according to certain embodiments. System 100 is presented as a typical multi-media configuration and it should be understood that more or fewer devices may be included in any suitable configuration or arrangement, as would be appreciated by one of ordinary skill in the art with the benefit of this disclosure. System 100 can include a remote 110 and hub 120 (remote/hub 105) to control system 100. System 100 can further include one or more display devices 130 (e.g., smart televisions, monitors, tablet displays, smart devices, etc.), audio controller(s) 140 (e.g., AVR), audio device(s) 145 (e.g., speakers, headphones, portable speakers (e.g., Logi® Boom®), etc.), media player(s) 150 (e.g., DVD players), media recorders 160 (e.g., DVRs), and media consoles 170(1)-170(N) (e.g., set top boxes (e.g., DirecTV, Comcast (broadcast satellite service providers), game consoles, streaming devices (e.g., to stream content from Netflix®, Amazon®, Hulu®, etc.). In some embodiments, system 100 may communicate with non-media related internet-of-things (IoT) devices (not shown) such as lights, appliances, HVAC controllers, and the like, or computing devices (e.g., laptop computer, desktop computer, etc.), as would be appreciated by one of ordinary skill in the art with the benefit of this disclosure.

Hub 120 and one or more media consoles may be coupled to one or more remote resources via an internet connection referred to generally as cloud 180. The connection to the internet can include direct coupling via an Ethernet port, wireless coupling through an Ethernet router, or any suitable means of enabling internet communication for any of the devices of system 100. Some remote resources can include code/content provider(s) 190, a voice analysis service provider 198, and one or more content service providers 195(1)-(N). Alternatively, rather than hub 120 and one or more elements (e.g., media consoles) having separate connections to cloud 180, some embodiments may have hub 120 configured as the intermediary between cloud 180 and system 100 for some or all of the one or more elements of system 100.

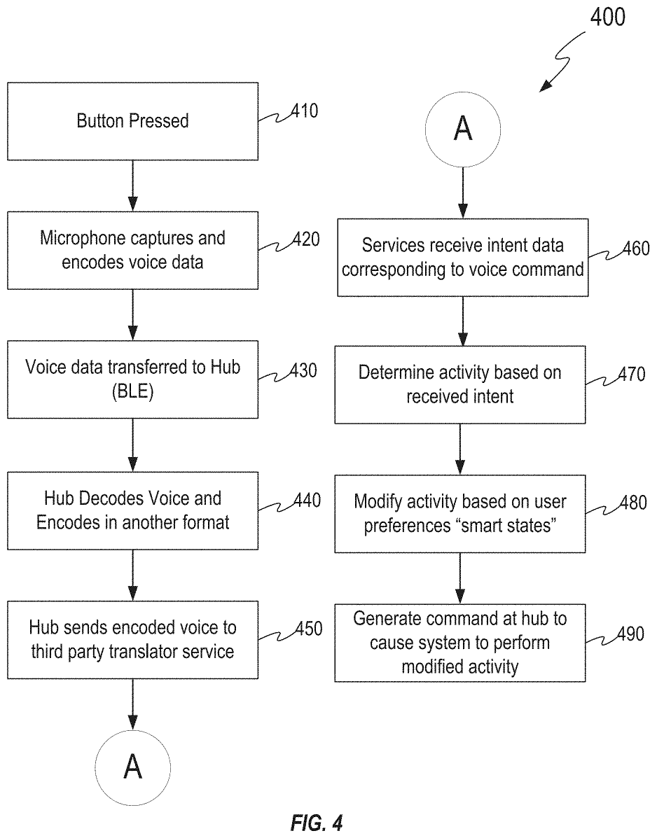

Code/content data provider(s) 190 may include a database for operational codes for programming the various devices in system 100 and/or can include programming information about a particular media platform including available channels, channel content, content metadata, or the like. For example, some code/content data providers may provide a database for operational codes for configuring DVR 160 in some or all of its corresponding modes of operation, or codes for changing an input or display resolution of display device 130. In short, code/content provider(s) 190 can provide hub 120 with the requisite information to control each device within system 100 using preferably native control codes. The operational codes can include Consumer Electronic Control (CEC) command codes. The CEC command codes may be the CEC command codes specified by the HDMI standard or may be custom CEC command codes, which are permitted by the CEC standard. Alternatively or additionally, the device control codes may be stored in a local database (e.g., within hub 120, a local laptop/desktop computer, or other system 100 resource). In some cases, code/content provider 190 (e.g., Grace Note®) may provide hub 120 with a catalog or channel guide of media channels and corresponding content for the available media resources in system 100 (e.g., indicating particular channels, such as CNN or FOX, and corresponding content, such as a particular sports game or TV show; examples of media resources that can provide such content include DirecTV® or Comcast®, Netflix, Hulu, etc.) and its corresponding content including program play times, play durations, media metadata (e.g., information about the media content), etc., over a particular day, week, month or other suitable time frame. System 100 (e.g., hub 120) can use this catalog data to configure the devices of system 100 to select a media resource (e.g., satellite cable box vs. streaming service) to better meet the request of the user. For example, if the user wants to watch a particular movie, system 100 can analyze the catalog data from each available media resource (provided by code/content provider 190) to meet the desired playback requirements (e.g., play time, video and/or audio playback specifications, etc.). In some embodiments, the various catalogs of different media providers can be provisioned by one or more remote and/or local resources as would be appreciated by one of ordinary skill in the art with the benefit of this disclosure. Although code/content provider 190 is described as a single remote entity, it should be understood that operational codes and media content catalog data can be provided by different entities. In some embodiments, a remote system operation service (e.g., Logitech Harmony), which can be part of code/content provider 190 or a separate entity, may operate in conjunction with hub 120 to determine whether certain user intent data (based on the user voice data) can be used to control system 100, and generate control data (e.g., CEC-based commands) to cause system 100 to play media content in a desired presentation, as further described below with respect to FIGS. 4-9.

Voice analysis service provider 198 may operate to translate the user's voice command (e.g., via a natural language processing) to determine a user's intent, which may be to watch a particular channel (e.g., MSNBC, FOX), a particular program (e.g., a season and episode of a particular sitcom), play a particular device of system 100, a combination thereof, or the like. Some examples of a voice analysis service provider may include Amazon® Alexa®, Apple® Siri®, Google® Assistant, or the like. The voice analysis service provider (“VASP”) 198 can then send the translated intent back to hub 120 via cloud 180, where hub 120 can use the intent to determine the appropriate system 100 configuration to present the media content to the user, as further discussed below. Although most of the embodiments below describe a remote VASP, some embodiments may employ a local VASP to determine a user's intent.

Content service providers (“CSPs”) 195(1)-(N) may include any number of remote media services (also referred to as “media sources” or “sources”) including cable-based media streaming service providers (e.g., Amazon, Netflix, Hulu, etc.), satellite-based media streaming service providers (e.g., DirecTV), or the like, which can be played via a corresponding media console (1-N).

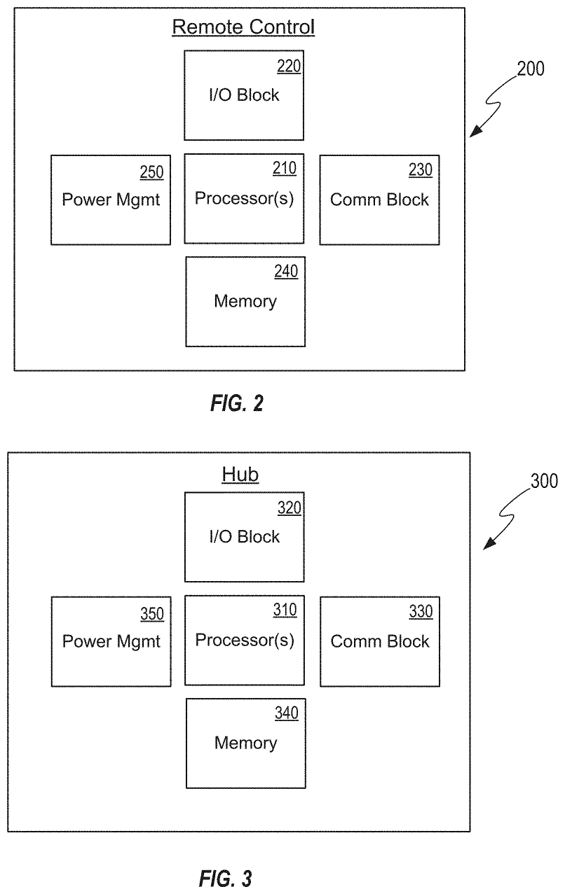

Remote control 110 may be configured as a universal remote to control the operation of system 100, according to certain embodiments. Remote control 110 may be communicatively coupled to hub 120 through any suitable wireless communication protocol including, but not limited to, Bluetooth®, BLE®, infra-red (IR), ZigBee, Z-Wave, Wi-Fi (e.g., IEEE 802.11x), radio frequency (RF), or the like. Remote control 110 may include a number of input/output (I/O) elements including a display 116, physical keys 114, voice input key 115, soft keys (presented on the display), touch sensitive regions, sliders, lights (e.g., LEDs), audio inputs (e.g., microphones), audio outputs (e.g., speaker 112), and the like. Remote control 110 and/or hub 120 may include non-volatile memory (e.g., ROM, RAM, etc.—not shown in FIG. 1) to store operational configurations, as further described below. In some embodiments, some of the various devices in system 100 may not connect directly to the Internet and may do so indirectly by way of personal computer (not shown) or other network device. As used herein the term database may comprise any suitable means for storing relevant information, such as command sets and features, for devices to be controlled. Databases can be implemented with relational database systems, simple lookup tables, or any other appropriate means of storing device information as will be apparent to those of ordinary skill in the art with the benefit of this disclosure. Although FIG. 1 shows both a remote 110 and hub 120, some embodiments may employ some or all of the functionality of hub 120 within remote 110 (see, e.g., the description of hub 120 corresponding to FIG. 3). For example, remote 110 may control the operations of the various media consoles, display devices, audio devices, recording devices, etc., as described above with respect to FIG. 1; and/or further communicate with content service providers, VASPs, etc., via the internet (e.g., cloud 180). Alternatively or additionally, some or all of the functionality of remote control 110 can be incorporated within hub 120 (see, e.g., the description of remote control 110 corresponding to FIG. 2). For example, hub 120 may receive inputs from a user including voice commands, physical inputs via buttons and/or touch sensitive interfaces, or the like. While the remote control 110 and hub 120 are described throughout this disclosure as separate entities, this disclosure contemplates the incorporation of some or all elements between the remote control 110 and hub 120 in the manner described above such that certain embodiments may employ both a remote control 100 and hub 120 or just one or the other, as would be appreciated by one of ordinary skill in the art with the benefit of this disclosure.

FIG. 2 shows a simplified block diagram 200 of a remote control device 110, according to certain embodiments. Remote control device (“remote control”) 110 may include processor(s) 210, input/output (“I/O”) block 220, communications block 230, memory block 240, and power management block 250. Each of system blocks 220-290 can be in electrical communication with processor 210. System 200 may further include additional systems that are not shown or described to prevent obfuscation of the novel features described herein. Further, any of system blocks 210-250 may be integrated with one another in any suitable combination, as would be appreciated by one of ordinary skill in the art with the benefit of this disclosure.

In certain embodiments, processor(s) 210 may include one or more microprocessors (μCs) and can be configured to control the operation of system 200. Alternatively or additionally, processor 210 may include one or more microcontrollers (MCUs), digital signal processors (DSPs), or the like, with supporting hardware, firmware (e.g., memory, programmable I/Os, etc.), and/or software, as would be appreciated by one of ordinary skill in the art. Alternatively, MCUs, μCs, DSPs, ASIC, programmable logic device, and the like, may be configured in other system blocks of system 200. For example, communications block 250 may include a local processor to control communication with hub 120 (e.g., via Bluetooth, Bluetooth LE, RF, IR, hardwire, ZigBee, Z-Wave, Logitech Unifying, or other communication protocol). In some embodiments, multiple processors may enable increased performance characteristics in system 200 (e.g., speed and bandwidth), however multiple processors are not required, nor necessarily germane to the novelty of the embodiments described herein.

I/O block 220 can control the detection of physical button 114 activation (e.g., media control buttons, system 100 device selection, etc.), sliders, switches, touch sensors (e.g., one and/or two-dimensional touch pads), and the like. I/O block 220 can include one or more touch sensitive surfaces or touch sensors and can be configured to detect a touch or touch gesture thereon. Touch sensors generally comprise sensing elements suitable to detect a signal such as direct contact, electromagnetic or electrostatic fields, or a beam of electromagnetic radiation. Touch sensors can typically detect changes in a received signal, the presence of a signal, or the absence of a signal. A touch sensor may include a source for emitting the detected signal, or the signal may be generated by a secondary source. Touch sensors may be configured to detect the presence of an object at a distance from a reference zone or point (e.g., <5 mm), contact with a reference zone or point, or a combination thereof. Certain embodiments of remote control 110 may or may not utilize touch detection or touch sensing capabilities.

In some aspects, I/O block 220 can control the operating of haptic devices implemented on remote control 110. For example, input signals generated by haptic devices can be received and processed by I/O block 220. An input signal can be an input voltage, charge, or current generated by a piezoelectric device in response to receiving a force (e.g., user touch) on its surface. In some embodiments, I/O block 220 may control an output of one or more haptic devices on remote control 110. For example, certain parameters that define characteristics of the haptic feedback can be controlled by I/O block 220. Alternatively, haptic input/output control can be performed by processor 210 or in combination therewith.

I/O block 220 can include touch and/or proximity sensing capabilities. Some examples of the types of touch/proximity sensors may include, but are not limited to, resistive sensors (e.g., standard air-gap 4-wire based, based on carbon loaded plastics which have different electrical characteristics depending on the pressure (FSR), interpolated FSR, etc.), capacitive sensors (e.g., surface capacitance, self-capacitance, mutual capacitance, etc.), optical sensors (e.g., infrared light barriers matrix, laser based diode coupled with photo-detectors that could measure the time of flight of the light path, etc.), acoustic sensors (e.g., piezo-buzzer coupled with microphones to detect the modification of a wave propagation pattern related to touch points, etc.), or the like.

In some aspects, I/O block 220 can operate aspects of movement tracking for remote control 110. In certain embodiments, an inertial measurement unit (IMU) can be used for movement detection. An IMU may be comprised of one or more accelerometers, gyroscopes, magnetometers, or the like. Accelerometers can be electromechanical devices (e.g., micro-electromechanical systems (MEMS) devices) configured to measure acceleration forces (e.g., static and dynamic forces). One or more accelerometers can be used to detect three dimensional (3D) positioning. For example, 3D tracking can utilize a three-axis accelerometer or two two-axis accelerometers. Accelerometers can further determine a velocity, physical orientation, and acceleration of remote control 110 in 3D space. Any suitable type of IMU can be incorporated into remote control 110, as would be understood by one of ordinary skill in the art.

In some embodiments, I/O block 220 can control video processing on one or more displays on remote control 110. For example, remote control 110 may include a display screen 116 (e.g., liquid crystal display (LCD), mini/micro LEDs) to display information for a user on a graphical user interface (GUI). The GUI may present a graphical representation of a present physical and/or wireless connectivity between some or all of the devices in system 100. For instance, display 116 may show HDMI connections between media player(s) 150 and display 130, an optical cable between audio controller 140 and display 130, communicative connectively between hub 120 and some or all of the various devices of system 100. In some cases, display screen 116 can display configuration controls that allow a user to program existing connections between devices of system 100 to inform remote/hub 105 of the connectivity infrastructure within system 100 so that system 100 can properly/accurately route media resources (e.g., set display 130 to receive video data from media console 170(2)) in response to user commands (i.e., user intent). In some cases, display 116 may be touch sensitive and (in some settings) display icons, buttons, text, or other GUI-based elements, as would be appreciated by one of ordinary skill in the art with the benefit of this disclosure.

In certain embodiments, I/O block 220 can control audio processing on remote control 110. For example, remote control 110 may include one or more microphones to detect a user's voice and other audio data. I/O block 220 can then encode the detected audio data (e.g., via any suitable audio codec, such as but not limited to Bv32, Opus, pulse code modulation (PCM), or the like) and transmit the encoded audio to hub 120 via communications block 230, as further discussed below. Alternatively, I/O block 220 may pass the detected audio data to hub 120 without no audio encoding. I/O block 220 may further control the operation of one or more speakers on remote control 110 to provide an audio feedback to a user, which can include voice acknowledgements for received voice commands, voice confirmation of completed request, or other sounds, as further discussed below. Although many of the embodiments describe one or more microphones integrated with the remote control, some embodiments may have microphones integrated with hub 120, or with another elements of system 100, such as on the television (display 130), internet-of-things (IoT) accessories (e.g., thermostat), or the like. Typically, the voice data may be ultimately coupled to hub 120 for further processing (e.g., to send for intent data, as further described below), but any suitable communication path to allow system 100 to receive the intent data is contemplated herein, as would be appreciated by one of ordinary skill in the art with the benefit of this disclosure.

Communications (“Comm”) block 230 can be configured to enable communications between remote control 110 and hub 120 and/or other devices in system 100, according to certain embodiments. Communications block 230 can include one or more transceivers (e.g., RF, IR, ultrasonic, Z-Wave, ZigBee, Wi-Fi, Bluetooth, BLE, or other standard or proprietary wireless communication protocols) to provide said communications, which is typically a wireless communication protocol, however hard-wired embodiments are possible (e.g., via Universal Serial Bus (USB), FireWire, etc.). Some embodiments may utilize different types of cables or connection protocol standards to establish hardwired and/or wireless communication with other entities. Alternatively, the functions of I/O block 220 can be subsumed by processor 210, or in combination therewith.

Memory block 240 can include non-transitory, computer-readable storage media that can store program code, software programs, and/or data that provide the functionality of embodiments of the present disclosure. In some embodiments, memory block 240 can include a number of memories including main random access memory (RAM) for storage of instructions and data during program execution and read-only memory (ROM) in which fixed instructions may be stored. Memory block 240 can provide persistent (i.e., non-volatile) storage for program and data files, and can include a magnetic or solid-state hard disk drive, an optical drive along with associated removable media, a removable flash memory-based drive or card, and/or other types of storage media known in the art. It should be understood that “software” can refer to sequences of instructions that, when executed by processing unit(s) (e.g., processors, processing devices, etc.), cause system 200 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in-part to volatile working memory during program execution. From a storage subsystem, processing devices can retrieve program instructions to execute in order to execute various operations as described herein.

Memory block 240 can store a configuration database configured to store operational settings of the various devices of system 100. For example, memory block 240 may store display settings (e.g., resolution (e.g., HD, 1080p, 4K, etc.), brightness, sharpness, contrast, etc.) for display (TV) 130. In another example, memory block 240 may store audio settings including audio presentation (e.g., surround sounds 7.1/5.1, stereo, mono, etc.), volume settings, equalization, etc. Configuration database can further store combination of device settings for particular programming. For example, a particular user may prefer to watch sports in maximum available display resolution, thus remote control 110 (or hub 120, as described below) can cause system 100 to route media content (e.g., NBA® programming) from a media resource that can provide the highest quality video resolution. The configuration database can be any suitable type of relational database, hierarchical database, or other database type (e.g., look-up table) and may be stored in full or in part in memory block 240 and/or other memory resources (e.g., in hub 120) in system 100. In some embodiments, the configuration database may be related to individual users. For example, a first user may have a first set of operational settings based on their particular preferences, and a second user may have a second set of operational settings that may be similar or may differ from the first set of operational settings in any way, as would be appreciated by one of ordinary skill in the art with the benefit of this disclosure.

Power management block 250 can be configured to manage power distribution, recharging, power efficiency, and the like, for remote control 110. In some embodiments, power management block 250 can include a battery (not shown), a USB-based recharging system for the battery (not shown), and a power grid within system 200 to provide power to each subsystem (e.g., communications block 230, etc.). Alternatively, some embodiments may not include a dedicated power management block. For example, functional aspects of power management block 250 may be subsumed by another block (e.g., processor(s) 210) or in combination therewith.

It should be appreciated that system 200 is meant to be illustrative and that many variations and modifications are possible, as would be appreciated by one of ordinary skill in the art. While system 200 is described with reference to particular blocks (e.g., I/O block 220), it is to be understood that these blocks are defined for understanding certain embodiments of the invention and is not intended to imply that embodiments are limited to a particular physical arrangement of component parts. The individual blocks need not correspond to physically distinct components. Blocks can be configured to perform various operations, e.g., by programming a processor or providing appropriate processes, and various blocks may or may not be reconfigurable depending on how the initial configuration is obtained. Certain embodiments can be realized in a variety of apparatuses including electronic devices implemented using any combination of circuitry and software. Furthermore, aspects and/or portions of system 200 may be combined with or operated by other sub-systems as informed by design. For example, power management block 250 may be integrated with processor(s) 210 instead of functioning as a separate entity.

FIG. 3 shows a simplified block diagram 300 of a hub 120, according to certain embodiments. Hub 120 may include processor(s) 310, input/output (“I/O”) block 320, communications block 330, memory block 340, and power management block 290. Each of system blocks 220-290 can be in electrical communication with processor 310. System 200 may further include additional systems that are not shown or described to prevent obfuscation of the novel features described herein. Further, any of system blocks 310-350 may be integrated with one another in any suitable combination, as would be appreciated by one of ordinary skill in the art with the benefit of this disclosure. For the purposes of simplification without limitation, the operation of each block 310-350 may operate similarly to blocks 210-250 of FIG. 2, with differences described below according to certain embodiment of the invention.

In some embodiments, hub 120 can receive voice input data from remote control 110 (e.g., communications block 230). The received user voice commands may be received via any suitable wireless communication protocol (e.g., Bluetooth®, BLE, IR, etc.), as described above. The voice input data may be encoded (e.g., via audio codec). In some embodiments, hub 120 may relay the user input data to a remote third party (e.g., voice analysis service provider (“VASP”) 198—such as Amazon® Alexa®, Apple® Siri®, Google® Assistant, or the like) for further analysis (e.g., natural language processing) to generate intent data (i.e., determine the user's intent) based on the voice input data. Hub 120 may then receive the intent data from the third party and control system 100 accordingly. For example, hub 120 may then perform steps to determine the best media resource to present desired media content with preferred operational settings (e.g., determine media resources that can provide content 4K video, 5.1 audio, etc., and sequentially power said resources, set proper inputs, set levels, etc., accordingly to present the content per the user's preferences) based on the received intent data, as further described below with respect to FIGS. 4-9. In certain implementations, hub 120 or another local entity (e.g., in system 100) may perform natural language processing on the voice input data instead of remote VASP 198 to determine user intent.

Hub 120 may be configured to store (e.g., in memory block 340) user preferences for presenting media content (e.g., preferences for particular programming), media resources (e.g., hardware), or a combination thereof. For example, a user may prefer that video is to be presented in the maximum resolution possible, or that audio is to be presented in the highest fidelity surround sound available. In another example, a highest available resolution may be associated with hardware, such as a smart TV (130), media consoles (170), or other hardware device. Alternatively or additionally, an option for highest available resolution may be associated with particular media content, so a user may prefer that sports programs are always presented in the highest resolution, but other types of programming or channels (e.g., news channel) do not have resolution preferences (e.g., there may instead be a live-coverage preference, latest episode preference, or the like). Further still, some users may instead have global user preferences not associated with particular hardware or media content. For example, a user may want the maximum resolution possible for any content and hub 120 may select one media console over another if that one media console offers the same media content in a higher resolution video feed. User preferences may be established based on user history. For example, if a user historically watches sports via a particular media console, but watches news on a different media console, then the user preferences can be updated to route said media content accordingly when requested by a user. Some embodiments may employ any combination of the various user preferences. One of ordinary skill in the art with the benefit of this disclosure would appreciate the many modifications, variations, possible combinations, and alternative embodiments thereof. User preferences (and operational settings) are further discussed below in the examples that follow. In some aspects, there may be one or more types of preferences. For example, preferences may include user preferences (e.g., preferred TV channels with fewer commercials, reduce volume after 10 PM weekdays, etc., as further described above), system preferences (e.g., default to a 4K resolution display device if 4K content is available, etc.), or system recommendations (e.g., Roku® and Apple TV® may both be available, but perhaps only one can upscale the resolution of the content to a user's specific TV). One of ordinary skill in the art with the benefit of this disclosure would appreciate the many modifications, variations, and alternative embodiments thereof.

In some embodiments, hub 120 may store CEC codes or equivalent data for each of the devices of system 100 to control each of said devices. Some devices may have universal CEC codes or proprietary CEC codes. Hub 120 may include some or all of the codes to configure and operate each device accordingly, including powering each device up and down, changing operation settings (e.g., play, pause, channel selection, output selection, etc.) and the like. Hub 120 may poll some or all devices in system 100 to determine CEC codes or may receive CEC codes from a third party. In some embodiments, CEC codes may be provided to hub 120 with the intent data. For example, a third party may determine (e.g., using a local or remote lookup table) whether the user's natural language corresponds to commands corresponding to certain devices of system 100 (e.g., a request to turn on the TV) or related media content (e.g., request to listen to a particular radio station); in such cases, the third party may provide the corresponding CEC codes and hub 120 may coordinate the operational settings of the associated devices using said CEC codes, as would be appreciated by one of ordinary skill in the art with the benefit of this disclosure.

In further embodiments, hub 120 may generate control data to change operational settings of one or more devices in system 100 based on intent data. For example, in response to receiving intent data corresponding to a user voice input data requesting to watch “PBS News,” hub 120 may generate control data that causes a set top box to drive display device 130 (e.g., set display device to an HDMI input corresponding to the set top box), cause the set top box to switch to the requested channel, cause the AVR to set appropriate volume and surround sound settings, and cause DVR 160 to record the program for later playback. That is, hub 120 controls the operation and configuration of each device of system 100, which may be prompted by intent data corresponding to a user's voice input data, as further described below.

### Simplified Method of Controlling a Multi-Media System Using a Remote Control and Hub

FIG. 4 is a simplified flow chart showing aspects of a method 400 for configuring one or more devices in a system 100 to play requested media content in response to a voice command on a remote control device, according to certain embodiments. Method 400 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 400 can be performed by aspects of remote control 110, hub 120, VASP 198, system operation service 190, or a combination thereof.

At operation 410, method 400 can include receiving an indication that a button is pressed on remote control 110, according to certain embodiments. In some cases, the button may be pressed by a user before initiating a voice command (i.e., providing voice input data). The button can be a physical, discrete button, a soft button (e.g., on a display), or any suitable input element, as described above with respect to I/O block 220 of FIG. 2.

At operation 420, method 400 can include capturing the voice input data and encoding it, according to certain embodiments. The voice input data may be captured by one or more onboard microphones on remote control 110 (e.g., operated by I/O block 220). The microphone(s) may “listen” for voice data while the button (115) is pressed or in response to the button being pressed (e.g., for a period of 5 seconds). Alternatively or additionally, the microphone(s) may constantly or intermittently listen for a command word (e.g., such as “wake” or “hey harmony”) to trigger the microphone to turn on. The voice data can be encoded with any suitable audio codec (e.g., BV32, Opus, PCM, etc.). In some cases, the voice data can be stored or buffered using memory block 240. As described above, the voice input data can be captured by any microphone in system 100, which may be integrated with remote control 110, hub 120, or any other element of system 100 (e.g., display 130), as would be appreciated by one of ordinary skill in the art with the benefit of this disclosure.

At operation 430, method 400 can include transferring the captured voice data to hub 120, according to certain embodiments. Remote control 110 may transfer the voice data via hardwired connection (e.g., USB) or preferably a wireless connection (e.g., Bluetooth, BLE, IR, ZigBee, etc.). The voice data is typically encoded for data compression (to reduce the file size), otherwise potentially large audio files may be sent over limited bandwidth communication protocols (e.g., BLE), which could result in significant lag time. However, some preferably higher bandwidth protocols may be used to transfer uncoded voice data (e.g. .wav files) to hub 120. Alternatively or additionally, other types of data can be sent in addition to or in lieu of the voice data. For example, text data, touch screen data, or any other suitable user input may be entered on remote control 110 and used to determine intent data, as would be appreciated by one of ordinary skill in the art with the benefit of this disclosure.

At operation 440, method 400 can include hub 120 decoding the encoded voice data and encoding the data in a second format, according to certain embodiments. In some embodiments, decoding the encoded voice data may be performed using a same or similar codec as used to encode the voice data. The second encoded format is applied to the voice data to accommodate a data format for the third party voice analysis service provider 198. In some cases, the second encoded format may be PCM, Cortana, Bixby, Siri, or the like, as would be appreciated by one of ordinary skill in the art with the benefit of this disclosure. In some embodiments, a second encoded format may not be necessary and a standard compression scheme may be used in lieu of any specialty or proprietary formats for the third party voice analysis service. Alternatively or additionally, system 100 may include a voice analysis system (e.g., integrated with hub 120, coupled to and/or controlled by hub 120, etc.) and operation 440 (e.g., decoding and re-encoding in another format) may not be necessary.

At operation 450, method 400 can include sending the encoded voice data (in the second format) to the third party voice analysis service (e.g., Amazon® Alexa® voice service, Google® Assistant, etc., Apple® Siri®, or the like), according to certain embodiments. At operation 460, VASP 198 receives the voice data and can analyze the voice data (e.g., using natural language processing) to determine the intent of the user (e.g., what the user wants to do) and generate intent data (operation 470). For example, if the user presses button 115 and says “play Mozart,” VASP 198 may determine the intent of that statement by recognizing that the user wants to play music (Mozart) of a particular musical genre (classical music). As described above, VASP 198 may alternatively be local and part of system 100. VASP 198 may determine if the intent corresponds to services that can be provided by system 100. For example, if the intent of the user is to initiate a call to order a pizza from a local vendor, then VASP 198 may determine that the user intent is not actionable by system 100 and may not return the intent data to hub 120. Alternatively, the intent data 120 may be sent to hub 120 with an indication that system 100 has no pending action item in response to the user's voice data. However, because the user said “play Mozart,” VASP 198 can determine that the command is actionable by system 100. In some cases, this may be determined based on knowledge of the system resources of system 100, by determining if that intent is registered by a system operation service (e.g., Logitech Harmony, which can be part of code/content provider 190 or a separate entity) that can work in conjunction with hub 120 to control system 100, or a combination thereof. Hub 120 and/or system operation service can then receive the intent data and check to see if it matches with capabilities of system 100 (e.g., can system 100 perform the intended task—i.e., play Mozart). Referring to FIG. 1, “play Mozart” may be implemented by tuning AVR 140 to a classical music radio station or satellite provider, or search a local database of music files to find media content corresponding to Mozart. System 100 can then route the AVR 140 output to audio resources 145 for playback. Alternatively, system 100 may be configured to play video programming (e.g., a classical music station) corresponding to the selection. In either case, a match may be found and an activity can be determined based on the received intent (operation 470). Typically, intent data specifies some action (e.g., watch, tune to, activate, turn on, turn off, play, search, etc.) as well as some additional data that can depend on what the action is (e.g., media title, channel name, channel call sign, channel number, device name, category, name of subject (person) in media, etc.).

At operation 480, method 400 can include modifying the determined activity based on user preferences (also referred to as “smart states”), according to certain embodiments. For example, although “play Mozart” defines the media content that the user wants to play, certain user preferences may indicate that music (whether purely audio or video presentations) should be executed in the highest quality surround sound (thus the best audio source that can provide the best quality surround sound should be selected) and at a particular volume. The modification can be done at the system operation service provider, at hub 120, or a combination thereof. In some cases, the system operation service can send the commands to hub 120 to configure system 100 to perform the requested task (e.g., turn the requisite devices on/off, switch inputs, etc.).

At operation 490, method 400 can include hub 120 executing the various device commands (including the user preferences)—that is, configuring operational settings (e.g., turning devices on, setting inputs, switching to particular channels, etc.) of the devices in system 100 being used—and taking into account device specific operating parameters, according to certain embodiments. Some device specific operating parameters may include delays associated with powering on the device, delay in switching inputs, etc. Thus, the commands issued by hub 120 may be sequenced with certain delays (e.g., 1-2 seconds) to ensure that each device is powered on and in an operational state to respond accordingly.

It should be appreciated that the specific steps illustrated in FIG. 4 provide a particular method 400 for configuring one or more devices in a system 100 to play requested media content in response to a voice command on a remote control device, according to certain embodiments. Other sequences of steps may also be performed according to alternative embodiments. For instance, in any of the embodiments described in this disclosure, a user input may be provided via voice (as described), but alternatively or additionally may be provided by touch input (e.g., typing, icon selection, button presses, etc.), etc. In certain embodiments, intent may be determined remotely (e.g., VASP 198) or alternatively/additionally determined by local resources such as hub 120 (e.g., with comparable voice analysis capabilities), remote 110, or other resource (e.g., dedicated local resource that hub 120 communicates with to glean the user intent). In some cases, available content can be provided by a content service provider, by scraping data, for instance, from a menu channel on a particular media console, or other method, as would be appreciated by one of ordinary skill in the art with the benefit of this disclosure. In some embodiments, elements in the cloud (e.g., remote server) and/or local (e.g., hub 120) may determine the content is available, what resources are available, how to deliver content, etc. Some implementations may further allow user preferences/settings to follow a user, which can be applied to different systems. For example, a user may be visiting a relative's home with a different system and differing capabilities (but using a similar remote/hub system as described herein). The user may log-in on the different system and apply his/her user preferences to consume content in the different system (assuming appropriate privileges are established). In some aspects, control commands may be generated and sent to various devices, rather than physically routing and switching the media content, as further described above. Furthermore, additional steps may be added or removed depending on the particular applications. Any combination of changes can be used and one of ordinary skill in the art with the benefit of this disclosure would understand the many variations, modifications, and alternative embodiments thereof.

### Additional Method of Controlling a Multi-Media System Using a Remote Control and Hub

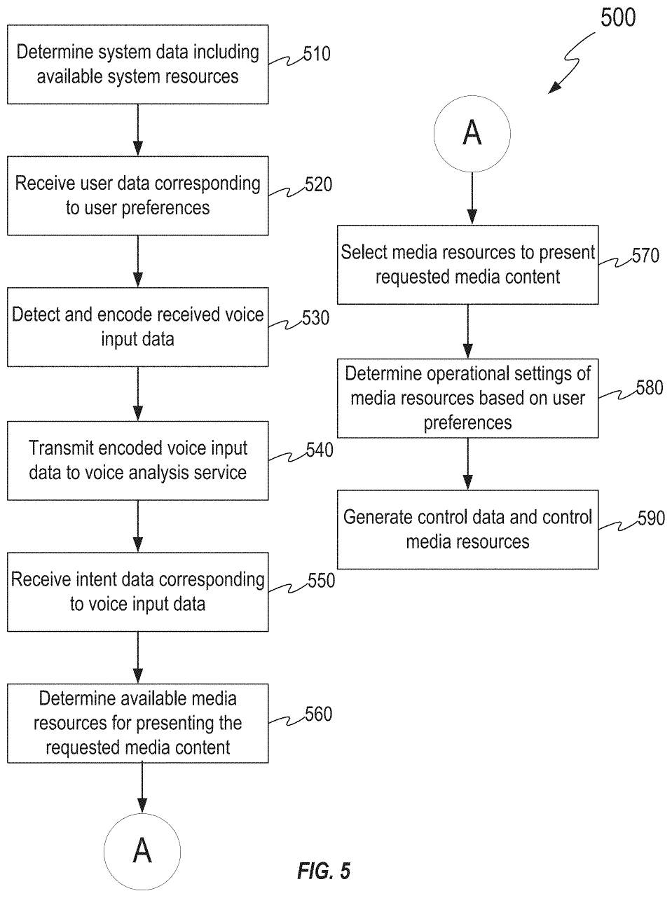

FIG. 5 is a simplified flow chart showing aspects of a method 500 for controlling a multi-media system 100 using a remote control 110 and hub 120, according to certain embodiments. Method 500 can be performed by processing logic that may comprise hardware (circuitry, dedicated logic, etc.), software (e.g., on one or more non-transitory computer-readable storage mediums that causes one or more processors to perform the operations described below—e.g., some or all of operations 510-590) operating on appropriate hardware (such as a general purpose computing system or a dedicated machine), firmware (embedded software), or any combination thereof. In certain embodiments, method 500 can be performed by aspects of remote 110 and hub 120 or a combination thereof. System 100 is referred to throughout the description of FIG. 5 (and other figures), however any suitable system comprising media resources can be used in conjunction with a remote control and hub system, as described herein.

At operation 510, method 500 can include determining system data including available media resources coupled to the home entertainment system (e.g., for system 100), the media resources including a plurality of independent media platforms, according to certain embodiments. System 100 can include a variety of media resources including media devices (e.g., SmartTVs, streaming devices, Blu-Ray players, DVR, set-top boxes, gaming consoles, etc.) which can provide media content. Some media devices may stream content from service providers (e.g., Netflix®, Hulu®, Amazon®, YouTube®, etc.). In some embodiments, the media platforms may be independent, such that a first media platform (e.g., DirecTV) does not access nor have control or information regarding the operation of other media resources in the multi-media system. The system data may be determine by polling some or all of the devices in system 100 (e.g., polled by hub 120, by a system operation service (e.g., Logitech Harmony or similar), input by a user (e.g., using a GUI interface on remote control 110 to enter devices and corresponding connections of system 100, or a combination thereof). System data can include unique identifiers, CEC codes, configuration data from lookup tables stored locally (e.g., in hub 120) or remotely (e.g., code/content provider 190). Devices in system 100 can be discovered manually (user input), automatically, or a combination thereof, and stored in any suitable database format, lookup table, or other means of storing system data, user preferences, or the like, as described throughout the present disclosure.

At operation 520, method 500 can include receiving user data corresponding to user preferences for presenting a plurality of types of media content, according to certain embodiments. User preferences can include preferences for media content. For example, some user preferences associated with movies may include video settings (e.g., select media resources with maximum resolution available), audio settings (e.g., select media resource with highest quality surround sound available), or the like. User preferences can include preferences for specific channels. For example, a request for “play the news” may opt for particular dedicated news channels. In some cases, user preferences may correspond to particular hardware. For example, a user preference may cause a DVR to always record a particular program from a video feed having the highest resolution, having no commercials, or the like. A non-limiting list of other user preferences may include a preferred device for a specific service, a time of day, a type of content (e.g., genre, format, etc.), rules based on which user is asking (e.g., hierarchy-based rules giving different users different levels of priority and access/control), and the like.

At operation 530, method 500 can include detecting a voice input data from a user, the voice input data detected by a microphone disposed in the remote control and controlled by processors, according to certain embodiments. For example, a user may press button 115 on remote control 110 and speak into a microphone 112 (e.g., dynamic or condenser microphone). The voice data may be stored and/or buffered in memory block 240 and then encoded into a first format. The first format can be any suitable compression method using an audio codec that may include .wav, .mp3, .aiff, .FLAC, etc.).

At operation 540, method 500 can include transmitting the encoded voice input data that is encoded in the first format to a remote entity (e.g., to VASP 198 from remote control 110 or hub 120). In some embodiments, the encoded voice input data can be transmitted via a wireless transceiver coupled to the remote control and controlled by the one or more processors. Some embodiments may employ hardwired coupling schemas. In alternative embodiments, the encoded voice input data may be sent from remote control 110 to hub 120, which in turn can decode the voice input data and re-encode in a second format as may be required by the remote entity, as described further at least with respect to FIG. 4.

At operation 550, method 500 can include receiving intent data from the remote entity in a second format, according to certain embodiments. The intent data can include a request for media content (e.g., a first media content, such as a movie) that is derived from the voice input data, the first media content being at least one of the plurality of types of media content (e.g., streaming content, static content (e.g., DVR, DVD, etc.), broadcasted content (e.g., satellite radio), or the like. In some cases, the intent may not be directed to playing media content. For example, the intent may correspond to turning on certain devices and configuring one or more I/O ports there between. In some embodiments, the intent data may be received instead from a local entity (e.g., from a natural language analysis system controlled by and/or coupled to hub 120 or other resource in system 100). Thus, a remote service (e.g., Amazon) may determine the intent of the user (e.g., what media content the user wants to see), but system 100 (e.g., hub 120, system operation service, or a combination thereof) determines how to deliver user's selected media content. For instance, the remote service may determine that a movie should be played, but system 100 (and/or a remote service) may determine that the movie should be played in 4K in the kitchen, because a first user is determined to be in the kitchen, and the first user has a higher priority than a second user in the living room.

At operation 560, method 500 can include determining available media resources for presenting the requested media content on the home entertainment system 100, according to certain embodiments. For example, the intent data may indicate that the user wants to watch a previously recorded sit-com program. Hub 120, for example, may determine that a set top box (e.g., Comcast) has the particular episode available for streaming and a DVR has it recorded, as well as an audio system and display to present the episode to the user. As described above, hub 120, remote control 110, a system operation service 190 (e.g., Logi® Harmony®), or a combination thereof may be used to determine the available media resources for presenting the requested media content. Furthermore, a code/content provider 190 (e.g., Grace Note®) may also provide programming for particular media resources (e.g., a catalog of programming across all channels, a catalog of content available for streaming, etc.). In some instances, system 100 (e.g., hub 120) may collect (e.g., scrape) this information from the various media resources in system 100 periodically, in real-time, on a need basis, etc.

At operation 570, method 500 can include selecting a combination of the available media resources that is capable of presenting the first media content based on the user preferences, according to certain embodiments. In the example above, two media resources were identified that can provide the requested media content. A selection may be informed based on user preferences that may include preferred video settings (e.g., video resolution), content settings (e.g., video with viewable metadata (e.g., scene information), video with no commercials, etc.), audio settings (e.g., surround sound specifications), content formatting (e.g., edited for TV/suitable for kids), conflict resolution (e.g., if watching with a particular media resource causes unintended consequences like cancelling one or more recordings concurrently running by said resource, then use the other resource), hierarchy management (e.g., video preferences have higher priority than content formatting), or the like. One of ordinary skill in the art with the benefit of this disclosure would appreciate the many possibilities, modifications, variations, and alternative embodiments thereof.

At operation 580, method 500 can include determining operational settings of the combination of available media resources based on the user preferences, according to certain embodiments. Operational settings can include the various modes of operation for the media resources to cause them to present the requested media content per the user preferences. For example, a user preference may be to display in 4K resolution whenever possible. Some corresponding operational settings may be to cause the media resource providing the media content to select a channel or memory to retrieve the media content in 4K format, to set the display (smart TV) to display 4K content, to set a volume for the audio system that corresponds to the user preferences (e.g., play a particular volume based on a type of content, a time of the day, etc.), to set the appropriate I/Os (e.g., set the display to select the HDMI input connected to the media resource with the 4K content), or the like. One of ordinary skill in the art with the benefit of this disclosure would appreciate the many possibilities, modifications, variations, and alternative embodiments thereof.

At operation 590, method 500 can include generating control data (e.g., control commands based on the CEC codes) operable to enable each of the combination of the available media resources to present the first media content according to their corresponding operational settings, according to certain embodiments. In some cases, this can include wirelessly controlling the combination of the available media resources with the generated control data. By way of example, enabling each of the media resources to present the media content may include configuring hardware devices to be powered on and selecting correct I/O ports, then sending commands to the various hardware devices to request the media content from the service providers (e.g., stream data) or directly if using an API, for example. Timing aspects of the control data can be factored in to the sequence of control commands. For instance, it may take a few seconds for a particular media resource to power up and switch to a particular mode of operation. The sequence of control commands may wait for this power up time before sending commands to request and/or play media content.

It should be appreciated that the specific steps illustrated in FIG. 5 provide a particular method 500 for controlling a multi-media system 100 using a remote control 110 and hub 120, according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

### Example: Operational Steps to Turn on a Device

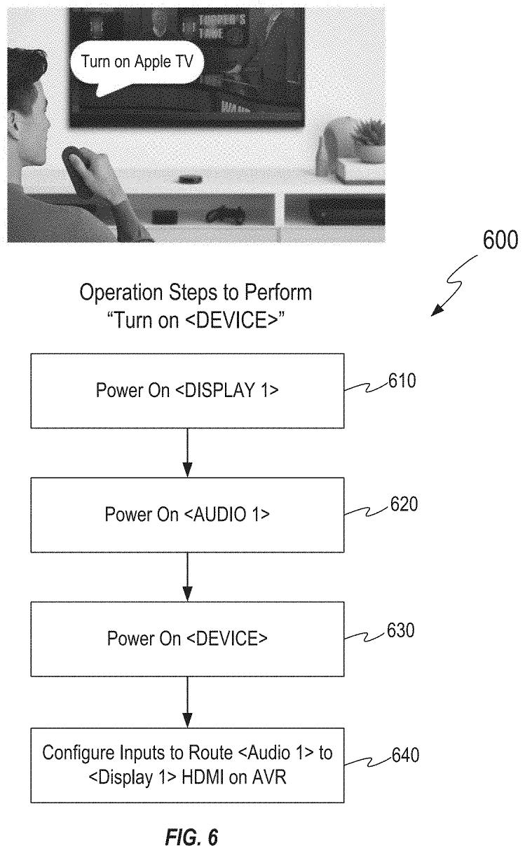

FIG. 6 is a simplified flow chart showing aspects of a method 600 for turning on a device (e.g., Apple TV®) after receiving a corresponding verbal command (e.g., “turn on AppleTV”) using aspects of system 100, according to certain embodiments. Method 600 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 600 can be performed by aspects of system 100, such as hub 120.

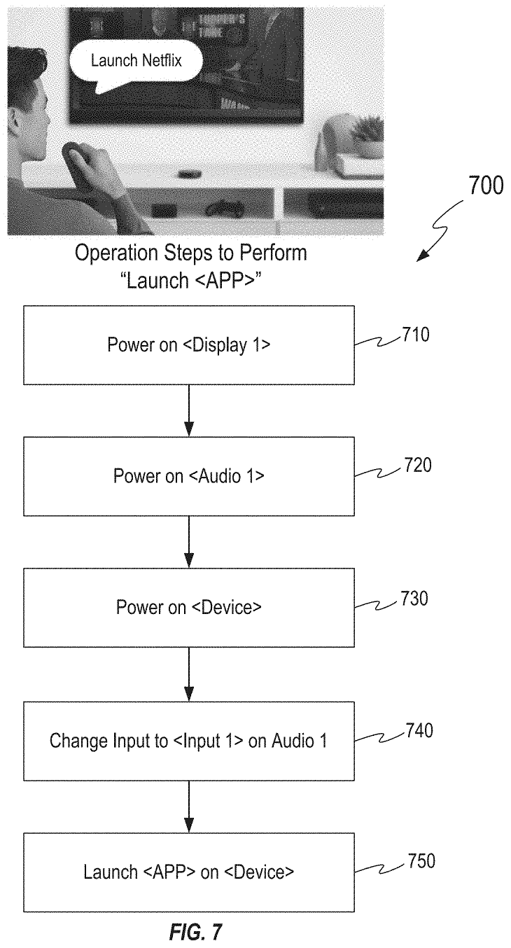

The foregoing steps are typically performed in a sequential order to ensure that all commands are received and implemented. Thus, the display devices should be powered on and allowed time to boot up before subsequent commands to select particular inputs (e.g., HDMI, component, optical input, etc.). It should be noted that the example provided in FIG. 6 as well as FIGS. 7-9 are illustrative of back end, high level processes that the user may see being performed, including devices powering on, switching to particular inputs, setting levels, etc. In other words, the other complex processes of, e.g., receiving the voice input, encoding it, sending the encoded data to another entity to determine a user intent, the analysis of the intent to see if it corresponds to tasks that can be performed by a particular system (100), determining available resources in the system and which can perform the intended task (e.g., turn on a device), and the like, as described above in more detail, are not presented here to illustrate, at a high level, the user friendly, efficient, adaptable, and powerful innovations used in typical, non-limiting use case scenarios.

At operation 610, method 600 can include powering on a display (130); powering on AVR 140 which control speakers 145 (operation 620); powering on the media resource (e.g., AppleTV® console—operation 630); and configuring an input on AVR 140 and display 130 to corresponding HDMI channels to receive audio and video from the AppleTV® console (operation 640).

It should be appreciated that the specific steps illustrated in FIG. 6 provide a particular method 600 for turning on a device after receiving a verbal command to do so using aspects of system 100, according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

### Example: Operational Steps to Launch an Application

FIG. 7 is a simplified flow chart showing aspects of a method 700 for launching an application (“app”) on a media resource in response to a corresponding verbal command (e.g., “launch Netflix”) using aspects of system 100, according to certain embodiments. Method 700 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 700 can be performed by aspects of system 100, such as hub 120.

At operation 710, method 700 can include powering on a display (130); powering on AVR 140 (operation 720); powering on the media resource (e.g., the device such as a media console that provides the app—operation 730); configuring an input on AVR 140 and display 130 to corresponding HDMI channels to receive audio and video from the media resource (operation 740); and launching the app (e.g., Netflix) on the device.

It should be appreciated that the specific steps illustrated in FIG. 7 provide a particular method 700 for launching an app after receiving a verbal command to do so using aspects of system 100, according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

### Example: Operational Steps for Tuning to a Particular Channel on a Media Resource

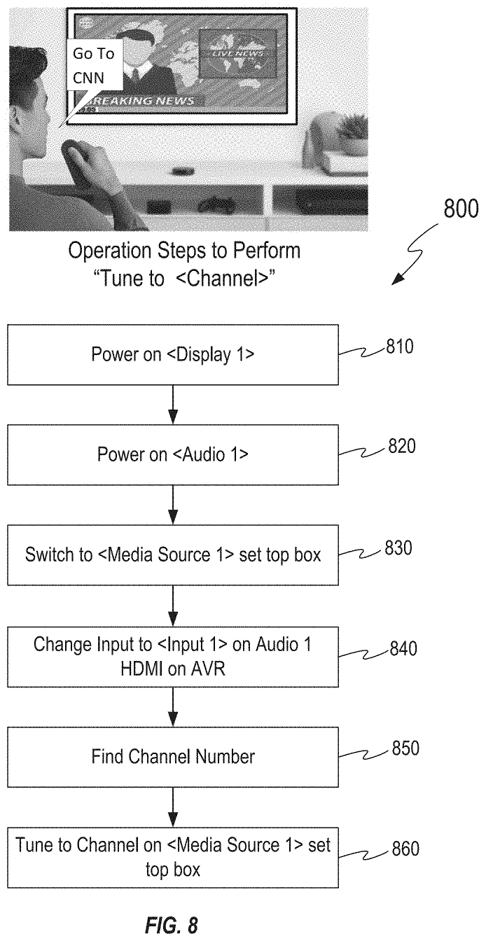

FIG. 8 is a simplified flow chart showing aspects of a method 800 for tuning a media resource (e.g., set top box—DirecTV®) to a particular channel in response to a corresponding verbal command (e.g., “Go to CNN”) using aspects of system 100, according to certain embodiments. Method 800 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 800 can be performed by aspects of system 100, such as hub 120.

At operation 810, method 800 can include powering on a display (130); powering on AVR 140 (operation 820); switching the display (e.g., selecting an HDMI input) to receive data from the media resource that can provide the channel (e.g., set top box—operation 830); switching an input on AVR 140 to a corresponding HDMI channels to receive audio from the media resource (operation 840); finding the channel number for the requested channel (e.g., provided by a third party (e.g., GraceNote®), scraped from a display generated by the media resource, etc.—operation 850); and tuning to the selected channel number (e.g., CNN) on the media resource (operation 860). As described above, aspects of the invention can respond to voice commands (e.g., “play CNN”) in a contextual manner. The instruction was to play CNN, but playback in an HD video format, 5.1 surround sound, and on a particular display (e.g., smart TV instead of a tablet computer screen) are the contextual considerations as informed by the previously set user preferences.

It should be appreciated that the specific steps illustrated in FIG. 8 provide a particular method 800 for tuning to a particular channel (e.g., CNN) on a media resource (e.g., set top box) to do so using aspects of system 100, according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

An important point of distinction between the embodiments described herein and other contemporary solutions is that content is presented contextually. With other systems, there may be macros or presets that dim lights and set a volume when you select a “movie” setting, but those system so not configure an entire entertainment system based on selected content. Here, the only input provided is, for example, a request for particular content. Once the system analyzes and determines the user's intent (to watch a particular movie), it can then make contextual decisions based on the content (e.g., set video/audio optimized per the user's preference for movies). That is, these settings do not have to be expressly provided by the user; rather, the system “figures it out” and configures system 100 accordingly and at a higher level of abstraction than contemporary systems.

### Example: Operational Steps to Select Particular Media Content

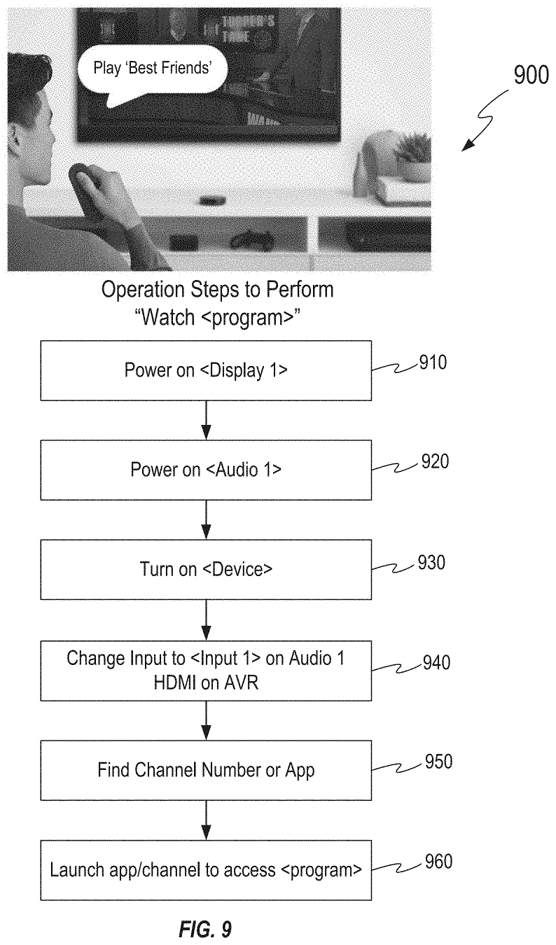

FIG. 9 is a simplified flow chart showing aspects of a method 900 for selecting particular media content (e.g., “Best Friends”) in response to a corresponding verbal command (e.g., “watch ‘Best Friends’”) using aspects of system 100, according to certain embodiments. Method 900 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 900 can be performed by aspects of system 100, such as hub 120.

At operation 910, method 900 can include powering on a display (130); powering on AVR 140 (operation 920); powering on the media resource (device) that can provide the media content (Best Friends—operation 930); switching an input on AVR 140 to a corresponding HDMI channels to receive audio from the media resource (operation 940); finding the channel number or app for the requested media content (operation 950); and launching the app/channel to access the media content (e.g., “Best Friends”—operation 960).

It should be appreciated that the specific steps illustrated in FIG. 9 provide a particular method 900 for launching a particular program after receiving a verbal command to do so using aspects of system 100, according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

The various embodiments further can be implemented in a wide variety of operating environments, which in some cases can include one or more user computers, computing devices or processing devices, which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local-area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, computer-readable storage media does not include transitory media such as carrier waves or the like.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A system comprising:
one or more processors; and
one or more non-transitory computer-readable storage mediums containing instructions configured to cause the one or more processors to perform operations including:
detecting input data from a user by a user interface device;
transmitting the input data to an intent detection service;
receiving intent data from the intent detection service, wherein the intent data includes at least a media type and a media identifier title derived from the input data;
determining one or more sources that is capable of providing media content associated with at least the media type and media identifier;
determining one or more operational properties of the media content, the operation properties corresponding to how the media content is configured to be output;
determining available media resources of a media presentation system that are capable of accessing the one or more sources and presenting the media content based on the operational properties;
selecting a combination of the available media resources that is capable of presenting the media content based on the operational properties of the media content and the capabilities of the available media resources;
determining operational settings of the combination of the selected media resources;
generating control data operable to enable the combination of the selected media resources to present the media content according to the corresponding operational settings; and
transmitting the control data to the media resources.

2. The system claim 1 wherein the user interface device includes a microphone controlled by at least one of the one or more processors, and wherein the input data from the user is voice data.

3. The system of claim 1 wherein the one or more non-transitory computer-readable storage mediums further contain instructions that cause at least one of the one or more processors to perform operations including at least one of:
receiving user preferences, the user preferences corresponding to a user's selected preference for presenting the media content;
receiving system preferences, the system preferences corresponding to preset system settings for presenting the media content; and
receiving system recommendations, the system recommendations corresponding to system recommended settings for presenting the media content,
wherein the operational settings of the combination of the selected media resources are further based on the at least one of the user preferences, system preferences, and system recommendations, and
wherein the generating control data is further based on the at least one of the user preferences, system preferences, and system recommendations.

4. The system claim 3 wherein the intent data is further derived from at least one of user preferences or the operational properties of the media resources.

5. The system claim 1 wherein determining available media resources of the media presentation system that are capable of accessing the one or more sources includes compiling the list of available media resources of the media presentation system based on a user input.

6. The system of claim 1 wherein determining available media resources of the media presentation system that are capable of accessing the one or more sources includes polling the media presentation system for a list of available media resources of the home entertainment system.

7. The system of claim 1 wherein the user's selected preference for presenting the media content corresponds to at least one of a video output, audio output, or internet-of-things accessory output.

8. The system of claim 1 wherein the user interface device is a remote control device.

9. The system of claim 1 wherein the instructions are further configured to cause the one or more processors to perform operations including:
determine a location of the user,
wherein selecting a combination of the available media resources that is capable of presenting the media content is further based on the location of the user.

10. The system of claim 1 wherein the control data includes:
power data configured to power on any of the combination of the available media resources that are turned off;
display data configured to control display parameters of a display device of the combination of the available media resources to present the media content; and
audio data configured to control audio parameters of an audio system of the combination of the available media resources to present the media content.

11. The system of claim 10 wherein the display data and audio data is sent a predetermined period of time after the power data is sent, the predetermined period of time corresponding to an amount of time to power on the corresponding combination of the available media resources.

12. The system of claim 1 wherein the control data includes a timing sequence of control commands configured to sequentially power up the combination of the available media resources that ensures that each of the available media resources in an operational state to receive and implement its corresponding control commands.

13. The system of claim 12 wherein the media content is a media channel, a media application, or a media program.

14. A remote control system configured for operating a home entertainment system, the system comprising:
one or more processors; and
one or more non-transitory computer-readable storage mediums containing instructions configured to cause the one or more processors to perform operations including:
determining system data including available media resources coupled to the home entertainment system, the media resources including a plurality of independent media platforms;
receiving user data corresponding to user preferences for presenting a plurality of types of media content;
detecting a voice input data from a user, the voice input data detected by a microphone coupled to the one or more processors;
encoding the voice input data to a first format;
wirelessly transmitting the encoded voice input data encoded in the first format to a remote entity, the encoded voice input data transmitted via a transceiver coupled to the remote control and controlled by the one or more processors;
receiving intent data from the remote entity in a second format, wherein the intent data includes a request for a first media content that is derived from the voice input data, the first media content being at least one of the plurality of types of media content;
determine one or more sources for the first media content;
determining available media resources for accessing the one or more sources and presenting the first media content on the home entertainment system;
selecting a combination of the available media resources that is capable of presenting the first media content based on at least one of:
the user preferences;
operational capabilities of the available media resources; and
a type of the first media content;
determining operational settings of the combination of available media resources based on the user preferences;
generating control data operable to enable each of the combination of the available media resources to present the first media content according to their corresponding operational settings, the remote control system not physically routing the first media data; and
controlling the combination of the available media resources with the generated control data.

15. The remote control system of claim 14 wherein the control data includes:
power data configured to power on any of the combination of the available media resources that are turned off;
display data configured to control display parameters of a display device of the combination of the available media resources to present the media content; and
audio data configured to control audio parameters of an audio system of the combination of the available media resources to present the media content,
wherein the display data and audio data is sent a predetermined period of time after the power data is sent, the predetermined period of time corresponding to an amount of time to power on the corresponding combination of the available media resources.

16. The remote control system of claim 14 wherein the media content is a media channel, a media application, or a media program.

17. The remote control system of claim 16 wherein the computer readable storage mediums further contain instructions that cause one or more processors and perform operations including: receiving user data corresponding to user preferences for presenting a plurality of types of media content.

18. The remote control system of claim 14 wherein determining available media resources of the home entertainment system that are capable of accessing the one or more sources includes compiling the list of available media resources of the home entertainment system based on a user input.

19. The remote control system of claim 14 wherein determining available media resources of the home entertainment system that are capable of accessing the one or more sources includes polling the home entertainment system for a list of available media resources of the home entertainment system.

20. The remote control system of claim 14 wherein the control data includes a timing sequence of control commands configured to sequentially power up the combination of the available media resources that ensures that each of the available media resources in an operational state to receive and implement its corresponding control commands.
